(19) United States
(12) Patent Application Publication
(10) Pub. No.: US 2006/0106725 A1
(43) Pub. Date: May 18, 2006

(54) Method, system, and program product for visual display of a license status for a software program

(75) Inventors: Paul Bernell Finley JR., Austin, TX (US); Daniel Nhiem Nguyen, Austin, TX (US); Kim-Khanh Vu Tran, Austin, TX (US); Vi Trieu Tran, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: INTERNATIONAL BUSINESS MACHINES CORPORATION, ARMONK, NY (US)

(21) Appl. No.: 10/988,467

(22) Filed: Nov. 12, 2004

(51) Int. Cl. G06F 17/60

(52) U.S. Cl. 705/59

(57) ABSTRACT

A software program on the computer system is represented by an icon, which is displayed to a user within one of several available icon-level graphical user interfaces (GUIs) of the operating system (OS). In addition to the standard icon displayed in the icon-level GUI, a license status symbol is associated/affiliated with the icon. The license status symbol indicates the license status of the particular application, from among shareware, un-licensed, valid license, expired license, expiring license, time to license expiration, and/or evaluation license. Each different license status is represented by a unique/identifiable license status symbol, and each application existing in one of these license status on the computer system are represented by its icon and associated/affiliated license status symbol. By viewing the icon and associated/affiliates license status symbol, a user is able to identify the specific license state of the application without having to open/run the application.

### BACKGROUND OF THE INVENTION

1. Technical Field

The present invention relates generally to software programs on computer systems, and in particular to license states of software programs on a computer system. Still more particularly, the present invention relates to a method, system, and program product for tracking license states of software programs on a computer system.

2. Description of the Related Art

A growing number of software products are being provided to users with specific utilization licenses, which authorizes the user to utilize the associated software program for only a predefined period of time. For example, the license may provide a number of days within which a user or is allowed to use the product, and after which the license expires. Beyond the initial (and/or renewal) period, the license has to be renewed if the user desires to continue utilizing the software program. The user may be prompted to renew the license as soon as the license period approaches the expiration date.

With some of these software products, the license may be an evaluation license that enables the user to utilize the software program for an initial period before requiring the user to purchase an extended license. When the user fails to pay for the license extension, the user access to the program application may be terminated and/or the user is provided access to only the components of the software program that do not require a license (e.g., an older or incomplete version of the software program).

Typically, the license term is provided/displayed to the user during program installation or stated on the packaging of the software product. Beyond that initial display of the license term, the software program is designed with code that displays the license status to the user at the time the user initiates an opening of the software program (or application) on the computer system. In some instances, the display is provided only when the license is near expiration.

In most conventional computer systems, a software program loaded on to the computer system is represented by an icon on the computer's graphical user interface (GUI). The icon provides a quick and visible way for the user to open the software program (also referred to as a software application or simply application). When the user opens an application that has a license term associated therewith by left clicking on the application's icon, most conventional applications provide the user with an output of the license state of the application before opening the application.

Thus, prior to opening an application, the user may be provided with a pop-up window in which a message that the license is about to expire is displayed. The message also includes a request or query whether the user wants to extend the license period. The signaling of the end of a license period thus occurs when the user first opens the application.

One drawback to this method of informing a user when the license is approaching expiration or has expired is that the user is ignorant of the license status of the applications on his/her desktop until the user is actively opening the particular application. With a growing number of software products having time-restrictive license terms, a user's computer may have multiple applications with expired or expiring licenses at any given time. However, the user is left unaware of the number of days left in any specific license for any specific application unless the user actively opens that application to reveal the license message window.

Keeping track of the number of days left for each license is thus a time and labor intensive process, as the user opens up each application on his/her computer that may have an expiring license. It is thus very common that the user is unaware that it is time to renew the license until the license actually expires.

Currently, the only way to differentiate between various software licenses of different applications is to run the specific application. However, some applications may not run if a license has expired. Thus, at the time the user decides to open the application, the user is prompted to renew since the previous license has expired, and the user is prevented from continuing any further with the application. When an evaluation copy of an application has expired, the user must purchase a full copy of the software program.

Since the point of notification only occurs at the moment the application is run, the user is often frustrated to find that license to use the application has expired, and is forced to go through a renewal process, which may take several minutes. Thus, only at the time the user decides to open the application is the user prompted to renew the license due to the expiration of the previous license. When immediate use of the application is desired, the renewal process may require valuable minutes that the user does not have available.

The present invention thus recognizes that it would be desirable to provide a more efficient method for informing a user of license states of the software products on the user's computer system. The invention further recognizes that enabling a user to renew a software license without actually having to open the software product would be a welcomed improvement. These and other benefits are provided by the invention described herein.

### SUMMARY OF THE INVENTION

Disclosed are a method and a computer program product that enable the licensing status of software programs (applications) on a computer system to be displayed along with the icon of the application. A software program on the computer system is represented by an icon, which is displayed to a user within one of several available icon-level graphical user interfaces (GUIs) of the operating system (OS). In addition to the standard icon displayed in the icon-level GUI, a license status symbol is associated/affiliated with the icon. The license status symbol indicates the license status of the particular application, from among shareware, un-licensed, valid license, expired license, expiring license, time to license expiration, and/or evaluation license. Each different license status is represented by a unique/identifiable license status symbol, and each application existing in one of these license status on the computer system are represented by its icon and associated/affiliated license status symbol.

By viewing the icon and associated/affiliates license status symbol, a user is able to identify the specific license state of the application without having to open/run the application. In one embodiment, the license status symbol is appended to the application's icon, while in another embodiment, the license status symbol is placed adjacent to (besides, above or below) the application's icon.

Further, in one embodiment, several of the license status symbols are represented utilizing a stoplight icon with different color-coded license status, where red indicates that the license has expired and needs to be renewed, yellow (or amber) indicates that the license is about to expire and should be renewed within the near future, and green indicates that the license is still valid and is not close to expiring. In another embodiment, the standard icon for the application is replaced with an icon having and a number appended thereto representing the number of days left before the license expires. This number is decremented each day until the number reaches 0. The user is thus made aware of the exact number of days left before the license expires.

Finally, in one embodiment, rather than provide a visible license state symbol along with each application icon, the OS is modified to provide the license status when the pointing device (e.g., mouse pointer) is placed over the icon. Thus, in addition to providing the name of the underlying application, the OS provides any specific licensing data such as days to expiration.

The above as well as additional objectives, functions, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram illustrating the main components of a computer having a plurality of applications capable of executing thereon according to one embodiment of the present invention;

FIG. 2A is a table of exemplary icons paired with license state symbols, where applicable, according to one embodiment of the invention;

FIG. 2B illustrates the three stop-light-styled license state symbols from the table of FIG. 2A utilize in accordance with one embodiment of the present invention;

FIG. 3 is an graphical user interface (GUI) illustrating application icons along with their respective license status symbols within the program files folder of an OS, according to one embodiment of the invention; and

FIG. 4 is a flow chart illustrating the process by which an application is loaded on a computer system and represented with an icon and associated license status symbol, according to one embodiment of the invention.

### DETAILED DESCRIPTION OF AN ILLUSTRATIVE EMBODIMENT

The present invention provides a method, system, and a computer program product that a method and a computer program product that enable the licensing status of software programs (applications) on a computer system to be displayed along with the icon of the application. A software program on the computer system is represented by an icon, which is displayed to a user within one of several available icon-level graphical user interfaces (GUIs) of the operating system (OS). In addition to the standard icon displayed in the icon-level GUI, a license status symbol is associated/affiliated with the icon. The license status symbol indicates the license status of the particular application, from among shareware, un-licensed, valid license, expired license, expiring license, time to license expiration, and/or evaluation license.

Each different license status is represented by a unique/identifiable license status symbol, and each application existing in one of these license status on the computer system are represented by its icon and associated/affiliated license status symbol. In one embodiment, the license status symbol is appended to the application's icon, while in another embodiment, the license status symbol is placed adjacent to (besides, above or below) the application's icon. By viewing the icon and associated/affiliates license status symbol, a user is able to identify the specific license state of the application without having to open/run the application.

In another embodiment, the standard icon for the application is replaced with an icon having and a number appended thereto representing the number of days left before the license expires. This number is decremented each day until the number reaches 0. The user is thus made aware of the exact number of days left before the license expires.

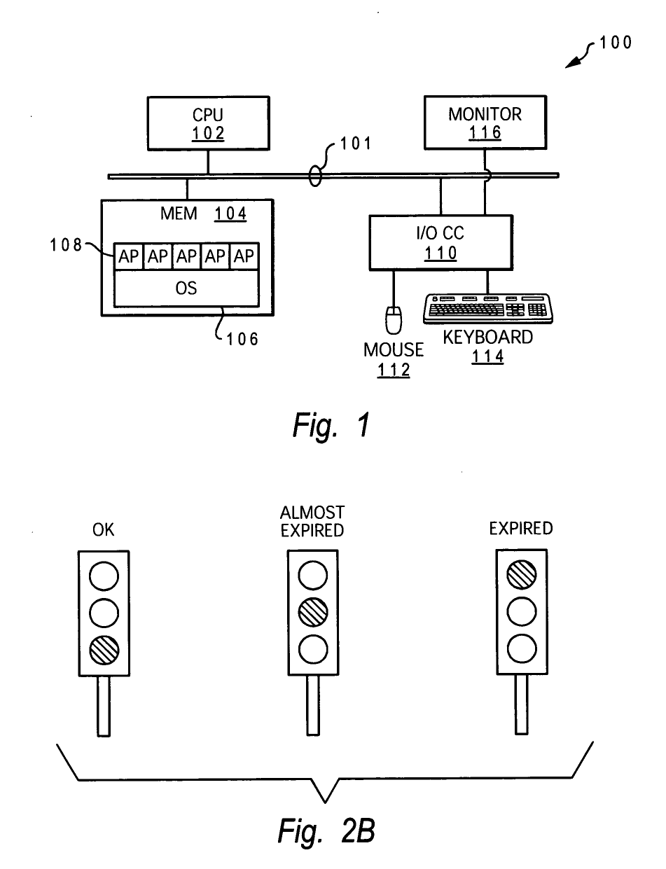

With reference now to the figures, and in particular to FIG. 1, there is illustrated an exemplary computer system within which the various features of the invention may advantageously be implemented. Computer system 100 includes a central processing unit (CPU) 102 connected to memory 104 and Input/Output Channel Controller (I/OCC) 110 via system bus 101. Connected to I/OCC 110 are several input and output devices of which mouse 112, keyboard, 114 and monitor 116 are illustrated.

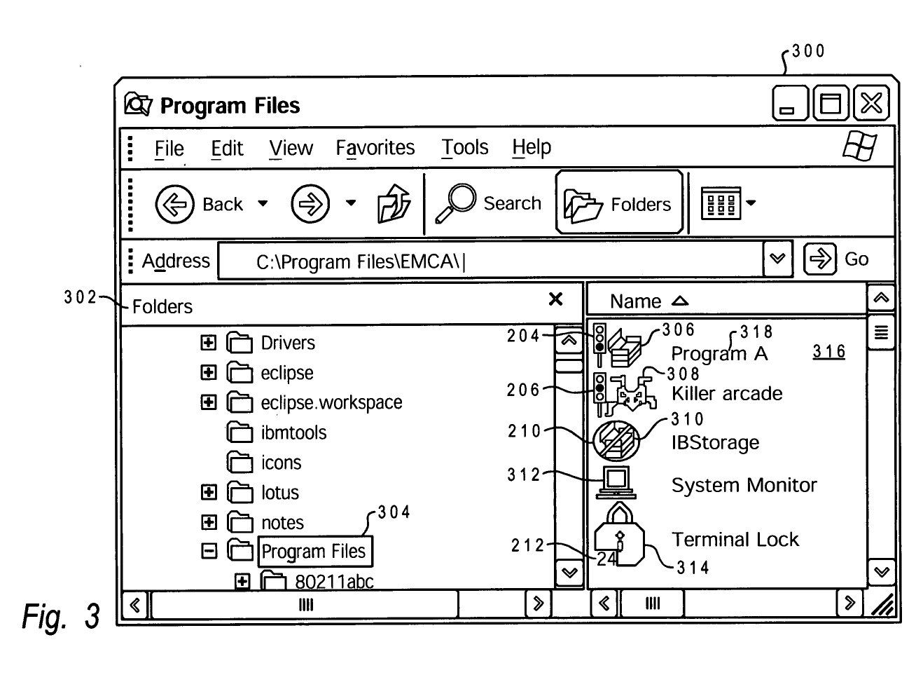

Illustrated within memory 104 are operating system (OS) 106 and a plurality of software programs (or applications) 108. Operating system 106 provides most of the functionality required for providing various GUIs for displaying icons associated with applications 108. OS 106 also enables opening and displaying of a program files GUI, which is displayed on monitor 116 and accessible to a user of the computer system 100 by mouse 112 and keyboard 114. One or more of the plurality of applications 108 may have an associated license that governs the length of time for which the application may be valid for execution on the computer system. According to the illustrative embodiment of FIG. 3, described below, each application 108 has an affiliated icon that represents the software program in the program files directory GUI.

For purposes of illustration, OS 106 is a Window's based operating system, such as Windows XP®, which is a trademark of Microsoft Corp. The functions of the invention are, however, applicable to any operating system that supports the display of licensing states for program applications. Thus, for example, the invention may also be implemented within a Linux-based operating system.

While computer system 100 is illustrated with specific hardware and software components, the invention is applicable to any type of computer system configuration so long as the background OS includes the enhanced licensing status symbol display features described herein. No structural or functional limitations are implied by the specific configuration and description thereof within the present specification.

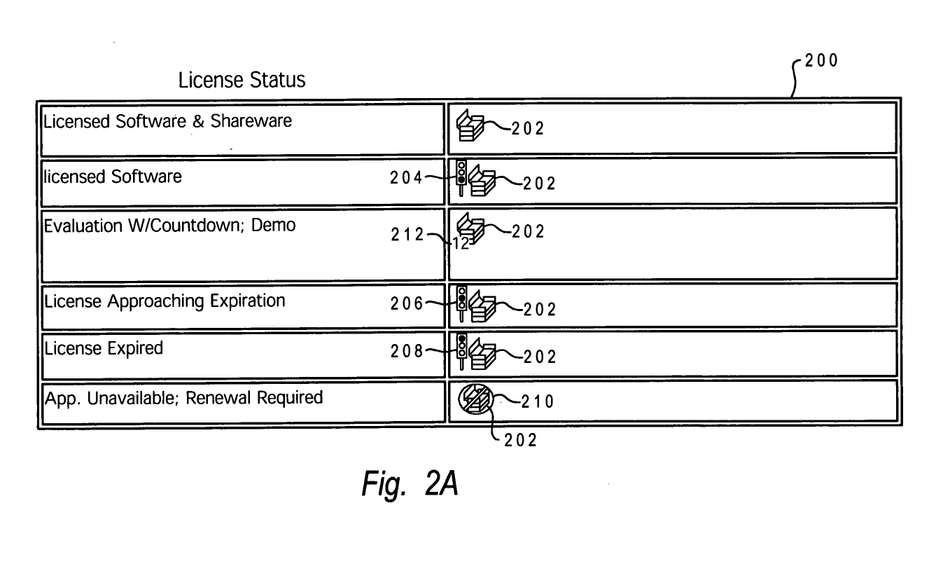

Turning now to FIG. 2A, there is illustrated a table of exemplary license status symbols. Table 200 includes two columns, with column two illustrating an application icon 202 and various license status symbols 204-212. Column one provides the definitions associated with each of the license status symbols 204-212. Depending on the license status of the application, the corresponding license status symbol is assigned/associated with icon 202. Table 200 thus illustrates the following assignments of license status symbols:
(1) icon 202 of an application that is unlicensed (i.e., no license associated with the application and thus no renewal required);
(2) licensed software status symbol 204, which is illustrated as a stop light icon with green light illuminated. This applies to an application whose license status is not close to a renewal point;
(3) license expiring symbol 206 is stop light icon with yellow (or amber) illuminated, indicating that the license is approaching the expiration date;
(4) license expired symbol 208 is stop light icon with red illuminated, indicating that the license has expired. For purposes of distinction, this symbol 208 does not indicate that the application is unavailable but that the license has expired. This distinction is better understood when compared to the next symbol;
(5) application unavailable symbol 210 is a circle with a bar placed directly over icon 202 indicating that the license has expired and the application can no longer be opened by the user; and
(6) license evaluation symbol 212 is actually an extension of icon 202 in which the number of days left in the evaluation period (i.e., before the license expires) is appended to icon 202. License evaluation symbol 212 is illustrated with 12 days remaining in the evaluation period.

Other symbols may be provided including, for example, shareware (which indicates unrestrictive license that does not expire) and demo, which indicates that a demo version of the application is being run. Shareware symbol may be synonymous with unlicensed software symbol 204. Likewise, demo symbol may actually be synonymous with license countdown symbol 212.

As described above and further illustrated by FIG. 2B, several of the license status symbols are represented utilizing a stoplight icon with positional, color-coded license status, where red indicates that the license has expired and needs to be renewed, yellow (or amber) indicates that the license is about to expire and should be renewed within the near future, and green indicates that the license is still valid and is not close to expiring.

In one alternate embodiment, rather than provide a visible license status symbol along with each application icon, the OS is modified to provide the license status when the pointing device (e.g., mouse pointer) is placed over the icon. Thus, in addition to providing the name of the underlying application, the OS provides any specific licensing data such as days to expiration.

FIG. 3 illustrates an exemplary program files directory GUI 300 within which features of the invention may be practice. Program files directory GUI 300 is provided within the OS code. As utilized herein, program files directory GUI 300 refers to a window within which is displayed a selection of available icons associated with each of the software programs installed/loaded on the computer system. A user is able to select any one of the icons, and selection of the icon results in the associated application opening on the computer system. The user selections may be via a mouse or other selection mechanism. Other means of interacting with program files directory GUI may be provided in alternative implementations.

Illustrated within program files directory GUI 300 is folders column 302, within which a list of available folders of files and/or applications is displayed. Program files folder 304 is one of the available folders within folders column 302, and program files folder 304 is utilized to store the icons associated with the executable files of the various applications available on the computer system. While the invention is described with reference to this specific program files directory GUI 300 and program files folder 304, the invention is applicable to any display of a program icon that is linked to an application subject to a license, irrespective of the location of the icon on the computer system. Thus, the features of the invention apply to icon on the desktop of a computer system and other directories and/or folders on the computer system.

Thus, as illustrated, program files directory GUI 300 also includes application space 316 in which is displayed the icons of the available applications within the folder 304. These icons exist within program files folder 304 in folders list 302. Program files folder 304 is shown opened within program files directory GUI 300 to reveal the various icons with associated license status symbols that may be selected by a user of the computer system selection.

As shown, application space 316 includes multiple icons of available applications. Where applicable, each icon has an associated license status symbol. Besides each icon is the name 318 of the software program for which the icon is affiliated. Reference herein to the particular icons will thus be via their respective names. Also, the license state (or status symbol) affiliated with each icon, where applicable, is determined by reference to the symbols provided by FIGS. 2A and 2B, for consistency.

Thus, program A icon 306 has licensed software status symbol 204 affiliated therewith, indicating that the application has a license that is not near to expiration. Killer arcade icon 308 has license expiring symbol 206, which alerts the user that the application's license will soon expire. IBStorage icon 310 is surrounded by application unavailable symbol 210. IBStorage application can no longer be opened using the IBStorage icon 312, based on the definition attributed to the application unavailable symbol 210. In one embodiment, this may also signal that a new copy of the IBStorage application has to be loaded on to the computer system. System Monitor icon 312 has no license symbol affiliated therewith since system monitor application is not restricted by a software license. Finally, terminal lock icon 314 has license evaluation symbol 212 appended thereto to indicate to the user that the application is a demo/evaluation copy (or a time-limited application) with only 24 days left to utilize the application.

In one alternative embodiment, the application icons are provided without a visible license status symbol associated therewith. However, when the user right clicks on an icon, and selects the preferences option, a “license term” feature is provided, which when selected displays the license term and time to expiration. In an alternative implementation, the license term is provided within the main list of options displayed by right clicking when the mouse pointer is positioned over the icon. In yet another implementation, the license term is provided when the user moves the mouse pointer over the icon, particularly when the license is approaching expiration or has a numeric count down component (i.e., days left to expiration).

Irrespective of the specific embodiment being utilized, one functional feature of the invention involves enabling the renewal of the applicable license associated with a software program to be tied to the icon and/or license status symbol. According to this feature, the user may click on the license status symbol to open a license renewal window. The user may then renew the license by entering required information within the license renewal window. This feature enables software license renewals without the user having to open (or attempt to open) the application to trigger the renewal request window as is commonly required today.

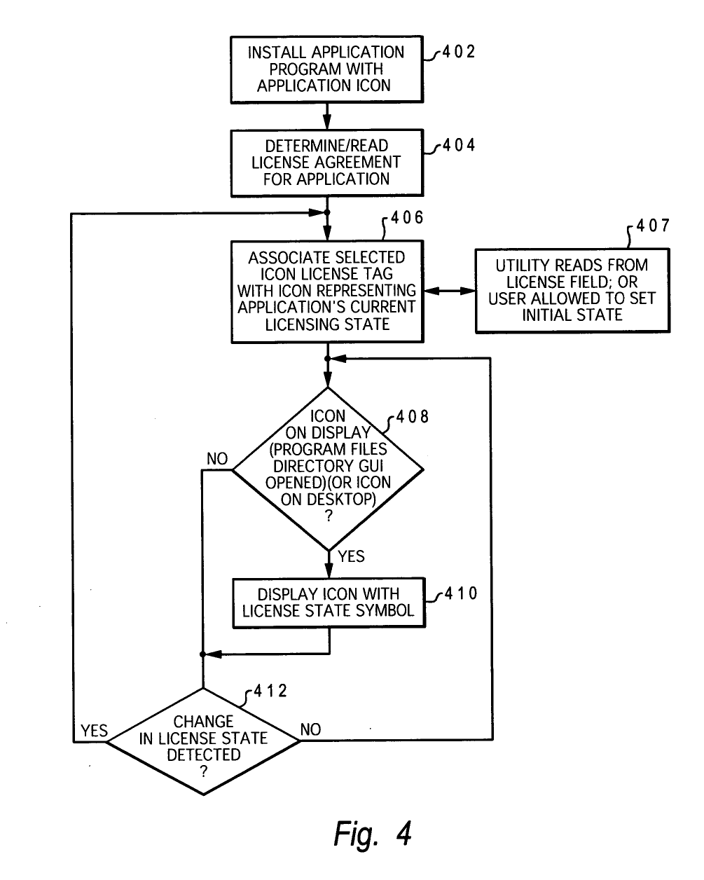

Operation of the various license features is now described with reference to the FIG. 4 flow chart. The process of FIGS. 4 begins at block 402, at which an application is loaded/installed on the computer system. During the installation process, an icon associated with the execution file of the application is provided and stored on the desktop or within the program folder of the OS. The OS installation utility reads the license parameters (if any) of the application at block 404, and then associates/appends an appropriate license status symbol with the application icon at block 406. The appropriate license status symbol (from among those described above) represents the application's current license state.

The installation utility may read the licensing parameters from a license field of the application's installation code or the user may be prompted to set (or pay for) an initial period for evaluation (e.g., software that automatically renews its license and charges the user for the renewal). Setting this period may involve selecting an expiration date, a display method (countdown or stop light symbol), and a frequency of display (continuous or intermittent or via right click options, etc.).

A determination is then made at block 408 whether the application's program icon is being displayed (e.g., a folder opened within which the icon is displayed). In the illustrative embodiment, the icon is displayed whenever program files directory GUI is opened or the icon displayed within the desktop. When the icon is being displayed, the license status symbol is also displayed along with the icon, as provided at block 410. A next determination is made at block 412 whether a change in the license state of the application is detected. If a change in the license state is detected, then current license status symbol is replaced with the license status symbol associated with the new license state.

Specific coding is required to enable the operating system to support the above-described functionality provided by the license tracking feature. The invention contemplates providing this coding as a separate license utility. This utility may be made available to users of existing operating systems. The utility may be provided as an update (or patch) to the operating system. Additionally, the utility may be packaged separately from the operating system and sold or distributed as a separate, licensed, add-on component. Finally, the utility may be coded within the specific application that has a license restriction.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a data processing system, a method comprising:
determining a current status of a license to utilize a software program on the data processing system; and
visually representing that status concurrent with an execution icon of the software program.

2. The method of claim 1, further comprising:
automatically changing a first visual representation of the current status to a second visual representation when the current status changes to another status, wherein the first and second visual representation indicates a different status from among multiple available status including no license, demo license, license current, license nearing expiration, number of days to expiration, license expired, and license expired with no access to software.

3. The method of claim 1, further comprising:
initiating a renewal process when the visual representation of the license status is selected by a user with a pointing device; and
opening a renewal window with options for renewal of the license for the software program.

4. The method of claim 1, further comprising:
when the visual representation of the license status is pointed to with a pointing device, displaying an indication of a license term remaining for the software program.

5. The method of claim 1, further comprising:
providing a selection of visual representations to a user when the software program is first installed on the computer system; and
enabling a user to selectively change the visual representation of the current status to a next visual representation.

6. The method of claim 1, further comprising:
representing a current status of the license with a color coded symbol, wherein a first color indicates a first status, a second color indicates a second status, such that each color indicates a different status.

7. The method of claim 1, wherein said visually representing of the current status includes:
opening a drop down list of selectable options when a user selects the execution icon;
displaying within the drop down list a license status selection; and
wherein, when the user selects the license status selection, a current status of the license is provided for the software program.

8. A computer program product comprising:
a computer readable medium; and
program code on the computer readable medium for:
determining a current status of a license to utilize a software program on the data processing system; and
visually representing that status concurrent with an execution icon of the software program.

9. The computer program product of claim 8, said program code further comprising code for:
automatically changing a first visual representation of the current status to a second visual representation when the current status changes to another status, wherein the first and second visual representation indicates a different status from among multiple available status including no license, demo license, license current, license nearing expiration, number of days to expiration, license expired, and license expired with no access to software.

10. The computer program product of claim 8, said program code further comprising code for:
initiating a renewal process when the visual representation of the license status is selected by a user with a pointing device; and
opening a renewal window with options for renewal of the license for the software program.

11. The computer program product of claim 8, said program code further comprising code for:
when the visual representation of the license status is pointed to with a pointing device, displaying an indication of a license term remaining for the software program.

12. The computer program product of claim 8, said program code further comprising code for:
providing a selection of visual representations to a user when the software program is first installed on the computer system; and
enabling a user to selectively change the visual representation of the current status to a next visual representation.

13. The computer program product of claim 8, said program code further comprising code for:
representing a current status of the license with a color coded symbol, wherein a first color indicates a first status, a second color indicates a second status, such that each color indicates a different status.

14. The computer program product of claim 8, wherein said program code for visually representing of the current status includes code for:
opening a drop down list of selectable options when a user selects the execution icon;
displaying within the drop down list a license status selection; and
wherein, when the user selects the license status selection, a current status of the license is provided for the software program.

15. In a data processing system, a system comprising:
program means for determining a current status of a license to utilize a software program on the data processing system; and
program means for visually representing that status concurrent with an execution icon of the software program.

16. The system of claim 15, further comprising:
program means for automatically changing a first visual representation of the current status to a second visual representation when the current status changes to another status, wherein the first and second visual representation indicates a different status from among multiple available status including no license, demo license, license current, license nearing expiration, number of days to expiration, license expired, and license expired with no access to software.

17. The system of claim 15, further comprising:
program means for initiating a renewal process when the visual representation of the license status is selected by a user with a pointing device; and
opening a renewal window with options for renewal of the license for the software program.

18. The system of claim 15, further comprising:
program means, when the visual representation of the license status is pointed to with a pointing device, for displaying an indication of a license term remaining for the software program.

19. The system of claim 15, further comprising:
program means for providing a selection of visual representations to a user when the software program is first installed on the computer system; and
program means for enabling a user to selectively change the visual representation of the current status to a next visual representation.

20. The system of claim 1, further comprising:
program means for representing a current status of the license with a color coded symbol, wherein a first color indicates a first status, a second color indicates a second status, such that each color indicates a different status.

21. The system of claim 1, wherein said visually representing of the current status includes:
program means for opening a drop down list of selectable options when a user selects the execution icon;
program means for displaying within the drop down list a license status selection; and
wherein, when the user selects the license status selection, a current status of the license is provided for the software program.
